(19) United States
(12) Patent Application Publication
(10) Pub. No.: US 2025/0293340 A1
(43) Pub. Date: Sep. 18, 2025

(54) POWER STORAGE DEVICE

(71) Applicant: TOYOTA JIDOSHA KABUSHIKI KAISHA, Toyota-shi (JP)

(72) Inventors: Kazuki SUGIE, Miyoshi-shi (JP); Akio MORI, Toyota-shi (JP); Yoshiro KAMO, Ashigarakami-gun (JP); Takahiko NAKANO, Nagoya-shi (JP); Toshihiro SHIMONAKA, Toyota-shi (JP); Kenichi KOHASHI, Sunto-gun (JP); Yuki SODA, Nagoya-shi (JP)

(73) Assignee: TOYOTA JIDOSHA KABUSHIKI KAISHA, Toyota- shi (JP)

(21) Appl. No.: 19/037,615

(22) Filed: Jan. 27, 2025

(30) Foreign Application Priority Data
Mar. 18, 2024 (JP) 2024-042047

(51) Int. Cl. H01M 10/6556; B60L 58/26; H01M 10/613; H01M 10/6554; H01M 10/6568; H01M 50/204; H01M 50/296; H01M 50/51

(52) U.S. Cl. CPC H01M 10/6556; H01M 10/613; H01M 10/6554; H01M 10/6568; H01M 50/204; H01M 50/296; H01M 50/51; B60L 58/26; H01M 2220/20

(57) ABSTRACT

A power storage device includes: a power storage module including an external terminal; a relay box provided at a position adjacent to the power storage module; a cooler provided in contact with the power storage module; and a main bus bar provided opposite to the power storage module with respect to the cooler and connected to the external terminal and the relay box. The cooler includes a supply portion supplied with refrigerant, and a flow path through which the refrigerant flows. The flow path includes an introduction portion extending from a portion of connection with the supply portion. The main bus bar includes an overlap portion extending so as to overlap the introduction portion. As a result, the main bus bar is provided so as to at least partially overlap the introduction portion through which cooler refrigerant flows than through a portion of flow path other than the introduction portion.

### CROSS REFERENCE TO RELATED APPLICATIONS

This nonprovisional application is based on Japanese Patent Application No. 2024-042047 filed on Mar. 18, 2024 with the Japan Patent Office, the entire contents of which are hereby incorporated by reference.

### BACKGROUND

### Field

The present disclosure relates to a power storage device.

### Description of the Background Art

In a conventional battery pack, a cooling device that cools a power storage module is disposed at a position for cooling a bus bar in a power storage device (see, for example, Japanese National Patent Publication No. 2023-510277).

### SUMMARY

Since a large current flows through the bus bar, the bus bar tends to have a higher temperature. In the structure as described in Japanese National Patent Publication No. 2023-510277, if the temperature of the bus bar increases, there is a risk that deformation of the bus bar in the direction of its extension will cause a large load to be applied to the terminal connected with the bus bar.

The present disclosure has been made to solve the problem described above. An object of the present disclosure is to provide a power storage device that makes it difficult for the bus bar to deform.

A power storage device according to the present disclosure includes: a storage battery including a connection terminal; a connection device provided at a position adjacent to the storage battery; a cooler provided in contact with the storage battery; and a main bus bar provided opposite to the storage battery with respect to the cooler and connected to the connection terminal and the connection device. The cooler includes a supply portion supplied with refrigerant, and a flow path through which the refrigerant flows. The flow path includes an introduction portion extending from a portion of connection with the supply portion. The main bus bar includes an overlap portion extending so as to overlap the introduction portion.

With this configuration, the main bus bar is provided so as to at least partially overlap the introduction portion through which cooler refrigerant flows than through the portion of the flow path other than the introduction portion. As a result, the main bus bar can be cooled sufficiently. Consequently, a power storage device can be provided that makes it difficult for the bus bar to deform.

The storage battery may include a plurality of power storage modules. Each of the plurality of power storage modules may have a positive electrode terminal and a negative electrode terminal, may charge and discharge electric power, and the plurality of power storage modules may be electrically connected in series. The connection terminal may include a collective positive electrode terminal and a collective negative electrode terminal. The collective positive electrode terminal may be the positive electrode terminal at a terminal end of the series connection of the plurality of power storage modules. The collective negative electrode terminal may be the negative electrode terminal at a terminal end of the series connection of the plurality of power storage modules. A first direction may be orthogonal to a second direction and a third direction. Each of the plurality of power storage modules may be longer in the third direction than in the first direction and the second direction, and have the positive electrode terminal and the negative electrode terminal respectively at opposite ends in the third direction. The plurality of power storage modules may be arranged in the first direction such that, at one end in the third direction, the positive electrode terminal and the negative electrode terminal of each of two adjacent power storage modules of the plurality of power storage modules are alternately aligned. The power storage device may further include a plurality of inter-module bus bars each connecting the positive electrode terminal and the negative electrode terminal of the two adjacent power storage modules to each other such that the plurality of power storage modules are all connected in series. The connection device may include a first terminal and a second terminal. The main bus bar may connect the first terminal to one terminal of the collective positive electrode terminal or the collective negative electrode terminal and may be provided at a position distant from the plurality of inter-module bus bars, the one terminal being located more distant from the connection device than the other terminal is from the connection device.

With this configuration, the main bus bar and the inter-module bus bar can be spaced away from each other. As a result, contact between the main bus bar and the inter-module bus bar can be suppressed.

The power storage device may further include a sub-bus bar connecting the second terminal to one terminal of the collective positive electrode terminal or the collective negative electrode terminal, the one terminal not being connected to the first terminal. The sub-bus bar may be provided at a position distant from the main bus bar.

With this configuration, the main bus bar and the sub-bus bar can be spaced away from each other. As a result, contact between the main bus bar and the sub-bus bar can be suppressed.

The cooler may further include a discharge portion through which the refrigerant is discharged. The flow path may include a discharge part leading to the discharge portion. The main bus bar may not include a part that overlaps the discharge part.

With this configuration, the main bus bar can be prevented from overlapping the discharge part, through which refrigerant having a higher temperature flows than through the part of the flow path other than the discharge part. Consequently, a temperature increase of the main bus bar can be prevented. This can make it difficult for the bus bar to deform.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic side view of a vehicle including a power storage device according to an embodiment of the present disclosure.

FIG. 2 is a schematic perspective view of the power storage device and a vehicle frame of the present embodiment.

FIG. 3 is a sectional view schematically showing the installation of the power storage device in the vehicle of the present embodiment.

FIG. 4 is a perspective view schematically showing a configuration of the power storage device of the present embodiment.

FIG. 5 is a perspective view showing a general shape of a power storage module included in the power storage device of the present embodiment.

FIG. 6 is a plan view schematically showing the interior of the power storage device of the present embodiment.

FIG. 7 shows the positional relationship between a refrigerant flow in a cooler and a main bus bar according to the present embodiment.

FIG. 8 shows a refrigerant flow in the cooler of the present embodiment.

FIG. 9 shows a refrigerant flow in a cooler of Embodiment 2.

### DESCRIPTION OF THE PREFERRED EMBODIMENTS

Embodiments and modifications thereof according to the present disclosure will be described with reference to the accompanying drawings. In the description below, the same components and constituent elements have the same reference characters allotted, and their labels and functions are also the same. Therefore, detailed description thereof will not be repeated. Note that the embodiments and modifications thereof described below may be selectively combined as appropriate.

### Embodiment 1

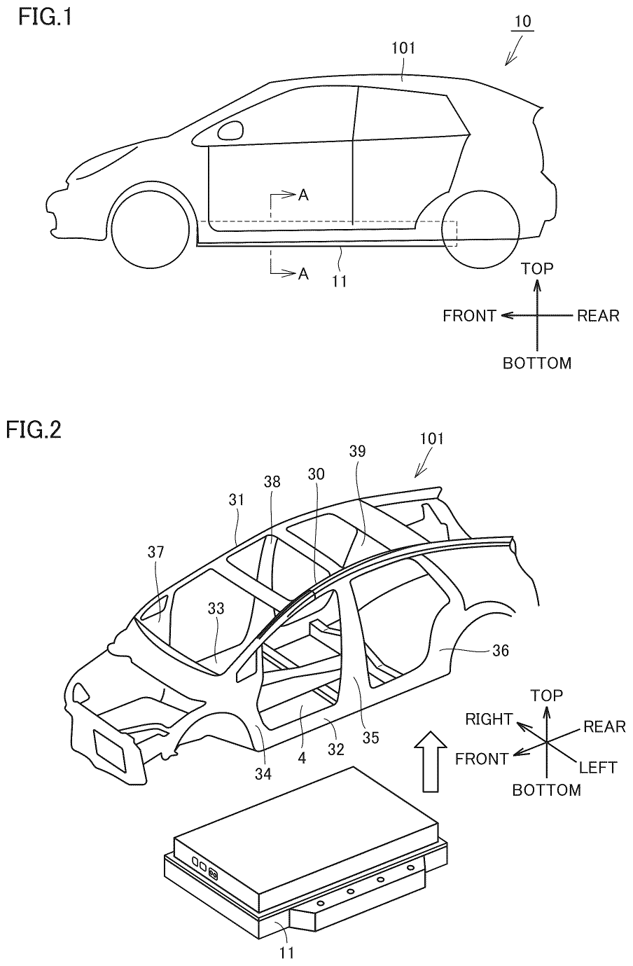

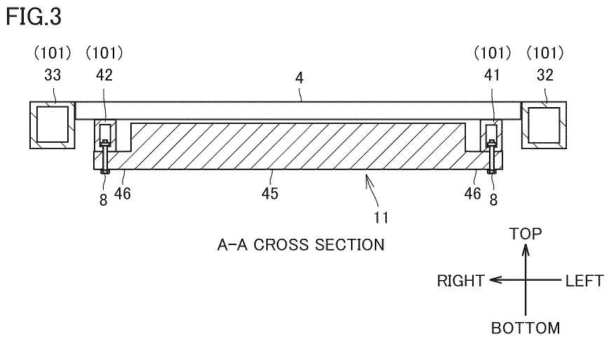

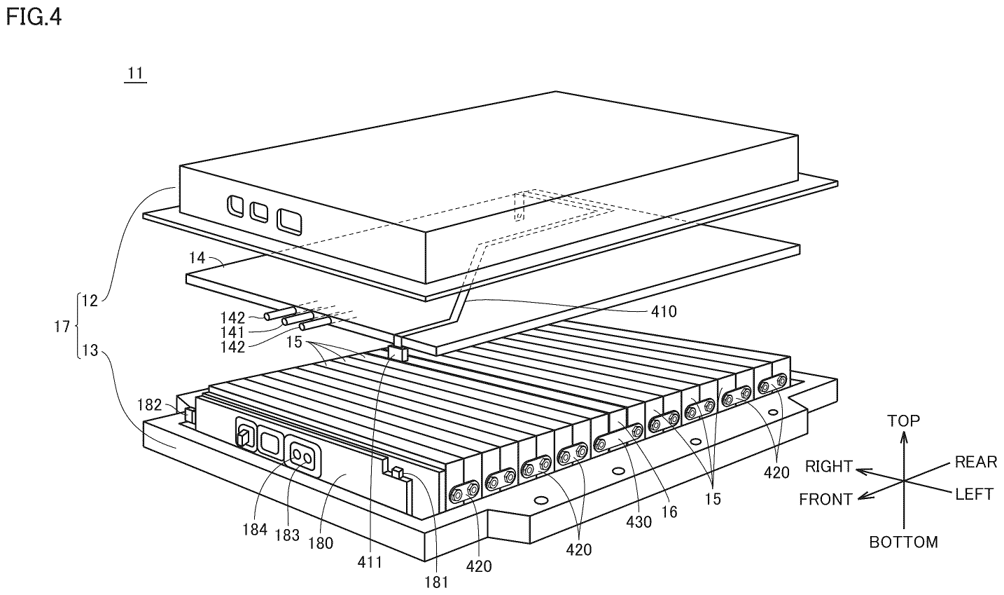

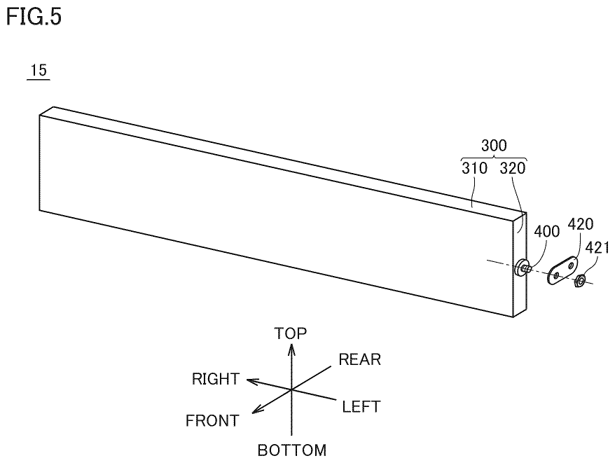

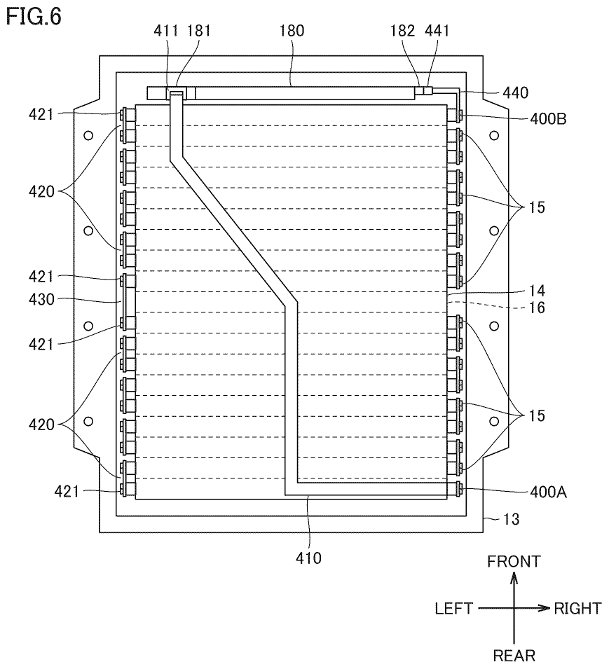

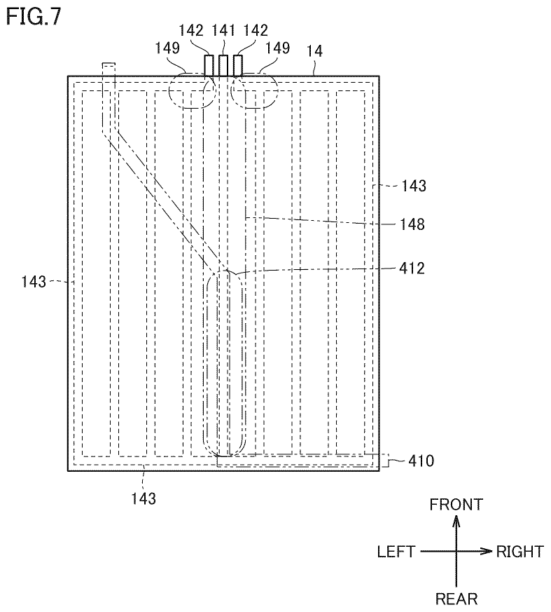

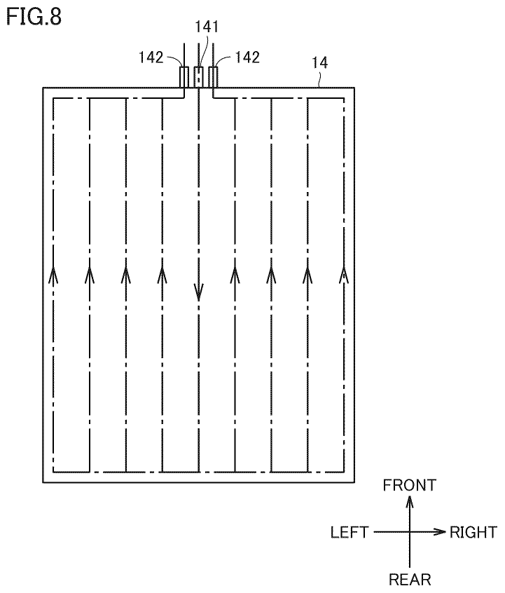

Referring to FIGS. 1 to 8, description will be given of a power storage device 11 and a vehicle 10 including power storage device 11 according to Embodiment 1. FIG. 1 is a schematic side view of vehicle 10 including power storage device 11 according to an embodiment of the present disclosure. FIG. 2 is a schematic perspective view of power storage device 11 and a vehicle frame 101 of the present embodiment. FIG. 3 is a sectional view schematically showing the installation of power storage device 11 in vehicle 10 of the present embodiment. FIG. 4 is a perspective view schematically showing a configuration of power storage device 11 of the present embodiment. FIG. 5 is a perspective view showing a general shape of a power storage module 15 included in power storage device 11 of the present embodiment. FIG. 6 is a plan view schematically showing the interior of power storage device 11 of the present embodiment. FIG. 7 shows the positional relationship between a refrigerant flow in a cooler 14 and a main bus bar 410 according to the present embodiment. FIG. 8 shows a refrigerant flow in cooler 14 of the present embodiment.

Referring to FIGS. 1 to 8, the front direction, rear direction, upward direction, downward direction, right direction, and left direction are the front direction, rear direction, upward direction, downward direction, right direction, and left direction, respectively, of vehicle 10. The axes in the front-rear direction, upward-downward direction, and left-right direction are orthogonal to one another.

Vehicle 10 is an electrically-powered vehicle. The electrically-powered vehicle may be a battery electric vehicle (BEV), a plug-in hybrid electric vehicle (PHEV), a hybrid electric vehicle (HEV), or a fuel cell electric vehicle (FCEV).

As shown in FIG. 1, vehicle 10 includes vehicle frame 101 and power storage device 11. Power storage device 11 is a device capable of charging and discharging electric power for driving vehicle 10. Power storage device 11 is disposed below a floor panel 4. However, the present disclosure is not limited to thereto, and power storage device 11 may be mounted at the bottom of the body of vehicle 10 to form part of the floor of the vehicle cabin.

As shown in FIG. 2, vehicle frame 101 includes a left roof rail 30, a right roof rail 31, a left side sill 32, a right side sill 33, a left first pillar 34, a left second pillar 35, a left third pillar 36, a right first pillar 37, a right second pillar 38, and a right third pillar 39. Left roof rail 30 and right roof rail 31 are disposed above vehicle frame 101. Left roof rail 30 and right roof rail 31 are spaced apart from each other in the left-right direction of vehicle 10. Left roof rail 30 and right roof rail 31 are disposed to extend in the front-rear direction of vehicle 10.

Left side sill 32 and right side sill 33 are disposed at the bottom of vehicle frame 101. Left side sill 32 and right side sill 33 are spaced apart from each other in the left-right direction of vehicle 10. Left side sill 32 and right side sill 33 are disposed to extend in the front-rear direction of vehicle 10.

Left first pillar 34, left second pillar 35, and left third pillar 36 are disposed on the left side of vehicle frame 101. Left first pillar 34 is provided to connect the front end of left side sill 32 to the front end of left roof rail 30. Left second pillar 35 is provided to connect the middle portion of left side sill 32 to the middle portion of left roof rail 30. Left third pillar 36 is provided to connect the rear end of left side sill 32 to the rear portion of left roof rail 30. In other words, left second pillar 35 is spaced apart from, and behind, left first pillar 34, and left third pillar 36 is spaced apart from, and behind, left second pillar 35.

Right first pillar 37, right second pillar 38, and right third pillar 39 are disposed on the right side of vehicle frame 101. Right first pillar 37 is provided to connect the front end of right side sill 33 to the front end of right roof rail 31. Right second pillar 38 is provided to connect the middle portion of right side sill 33 to the middle portion of right roof rail 31. Right third pillar 39 is provided to connect the rear end of right side sill 33 to the rear portion of right roof rail 31. In other words, right second pillar 38 is spaced apart from, and behind, right first pillar 37, and right third pillar 39 is spaced apart from, and behind, right second pillar 38. Floor panel 4 is provided between left side sill 32 and right side sill 33.

As shown in FIG. 3, vehicle frame 101 further includes a left side member 41 and a right side member 42. Left side member 41 and right side member 42 are disposed inside left side sill 32 and right side sill 33, respectively, with a distance in between in the left-right direction. Left side member 41 and right side member 42 are disposed to extend in the front-rear direction of vehicle 10.

A body portion 45 of power storage device 11 is disposed between left side member 41 and right side member 42. A clearance is provided between body portion 45 and each of left side member 41 and right side member 42. This can suppress input of impact to power storage device 11 even if vehicle 10 is involved in a side collision.

Power storage device 11 has fixed portions 46 on the opposite side surfaces of body portion 45 in the width direction of vehicle 10. Fixed portions 46 are fixed to left side member 41 and right side member 42 with fastening members 8.

As shown in FIGS. 4 to 6, power storage device 11 includes an upper case 12, a lower case 13, cooler 14, a plurality of power storage modules 15, a reinforcing member 16, a main bus bar 410, inter-module bus bars 420, 430, a sub-bus bar 440 (see FIG. 6), and a relay box 180.

Upper case 12 and lower case 13 are formed of steel material (e.g., steel plate). Upper case 12 and lower case 13 may also be formed of any other material such as resin. Upper case 12 and lower case 13 are joined together at flange portions thereof (e.g., fastened with bolts and nuts at the flange portions) into an integrally-formed power storage device case 17. A space is formed inside power storage device case 17. Upper case 12 is positioned above lower case 13. Power storage device case 17 is attached to vehicle 10 such that the thickness direction thereof is aligned with the upward-downward direction of vehicle 10. The longitudinal direction and the transverse direction of power storage device case 17, which are orthogonal to the thickness direction thereof, are aligned with the front-rear direction and the left-right direction, respectively, of vehicle 10. Power storage device case 17 is several times longer in the longitudinal direction and the transverse direction than in the thickness direction.

As shown in FIG. 5, power storage module 15 is a module capable of charging and discharging electric power, and has an approximately rectangular parallelepiped shape. The longitudinal side of power storage module 15 is several times longer than the transverse side, which is the longer of the remaining two sides. The transverse side is several times longer than the thickness direction side, which is the shorter of the remaining two sides. The longitudinal, transverse, and thickness directions of power storage module 15 correspond to the left-right, upward-downward, and front-rear directions, respectively, of vehicle 10.

As shown in FIGS. 4 and 6, power storage module 15 is accommodated in the internal space of power storage device case 17. Power storage module 15 is accommodated such that the longitudinal, transverse, and thickness directions thereof are aligned with the transverse, thickness, and longitudinal directions, respectively, of power storage device case 17. Power storage modules 15 are accommodated so as to be stacked in the thickness direction. Reinforcing member 16 is a member that reinforces lower case 13, and has an external shape that is approximately the same as that of power storage module 15, and is attached to the middle of lower case 13 in the longitudinal direction. In other words, reinforcing member 16 is provided in the middle of power storage modules 15 in the direction in which power storage modules 15 are stacked.

As shown in FIG. 5, power storage module 15 has at least one power storage cell (not shown) accommodated therein, a module case 300, and an external terminal 400. The power storage cell is formed of a lithium-ion battery. However, the present disclosure is not limited thereto, and the power storage cell may be formed of any other type of secondary battery, such as all-solid-state battery. Module case 300 is composed of a case body 310 and a lid 320. Case body 310 and lid 320 are made of, for example, aluminum. Case body 310 has a shape of an approximately rectangular parallelepiped with a hollow in the longitudinal direction. Lid 320 has a shape of a rectangular flat plate that closes the opening of case body 310. The external shapes of case body 310 and lid 320 constitute part of the external shape of power storage module 15 described above. Lid 320 is joined to case body 310 by welding to cover the opening of case body 310. The joining method is not limited thereto, and may be another method, such as using an adhesive.

As shown in FIGS. 4 to 6, external terminals 400 are provided on lids 320 at the opposite ends of power storage module 15 in the longitudinal direction. One of external terminals 400 at the opposite ends is a positive electrode terminal, and the other is a negative electrode terminal. Power storage modules 15 are disposed in power storage device case 17 such that the positive and negative electrode terminals of external terminals 400 are disposed alternately. Inter-module bus bars 420, 430 are conductor rods that allow a large-capacity current to flow therethrough, and are made of, for example, copper. External terminals 400, that is, the adjacent positive and negative electrode terminals, are electrically connected to each other by inter-module bus bar 420. External terminals 400, that is, the adjacent positive and negative electrode terminals with reinforcing member 16 sandwiched in between, are electrically connected to each other by inter-module bus bar 430, which has a longer hole distance than that of inter-module bus bar 420. External terminals 400 are inserted into the holes formed in inter-module bus bars 420,430 and are fastened so as to sandwich inter-module bus bars 420, 430 in between with the male screws formed in external terminals 400 and nuts 421. As a result, inter-module bus bars 420, 430 are fixed to power storage modules 15. This electrically connects power storage modules 15 inside power storage device case 17 in series.

Relay box 180 is provided at the position on the front end side of lower case 13 adjacent to power storage module 15. Relay box 180 includes electrical devices such as positive and negative relays for interrupting electrical connection between power storage modules 15 connected in series and the outside of power storage device 11, and sensors for measuring the voltage, current, temperature, and the like of power storage modules 15. Relay box 180 is provided with a positive bus bar connection terminal 181, a negative bus bar connection terminal 182, a positive external terminal 183, and a negative external terminal 184. Positive bus bar connection terminal 181 and positive external terminal 183 are connected to each other via the positive relay inside relay box 180. Negative bus bar connection terminal 182 and negative external terminal 184 are connected to each other via the negative relay inside relay box 180.

Main bus bar 410 and sub-bus bar 440 are conductor rods that allow a large-capacity current to flow therethrough, and are made of, for example, copper. A connector 411 at one end of main bus bar 410 is connected to bus bar connection terminal 181. The other end of main bus bar 410 is connected to an external terminal 400A (see FIG. 6), which is the collective positive electrode terminal at the terminal end of power storage modules 15 connected in series. A connector 441 at one end of sub-bus bar 440 (see FIG. 6) is connected to bus bar connection terminal 182. The other end of sub-bus bar 440 is connected to an external terminal 400B (see FIG. 6), which is the collective negative electrode terminal at the terminal end of power storage modules 15 connected in series. The portion other than the connection portions of main bus bar 410 and sub-bus bar 440 is covered with an insulator such as resin.

Cooler 14 is a device that controls the temperature of power storage module 15 by cooling power storage module 15. Cooler 14 may be changed to a temperature control device that has the function to heat power storage module 15 in addition to the cooling function. As shown in FIG. 4, cooler 14 is shaped into an approximately flat plate. The longitudinal and transverse directions of cooler 14 are shorter than the longitudinal and transverse directions of the inner surfaces of upper case 12 and lower case 13, respectively, and are aligned with these directions, respectively. Cooler 14 is attached to power storage modules 15 with an adhesive, for example, such that the surface thereof defined by the longitudinal and transverse directions of cooler 14 is in contact with the surface defined by the thickness and longitudinal directions of power storage modules 15. Cooler 14 may be attached to power storage modules 15 with an adhesive, as well as by any other method. Cooler 14 is accommodated in the internal space of power storage device case 17 together with power storage modules 15.

As shown in FIG. 7, a flow path 143, through which refrigerant (e.g., cooling water) for cooling power storage modules 15 flows, is provided inside cooler 14. The refrigerant is supplied from a supply portion 141 to flow path 143 by a pump (not shown) outside cooler 14. The refrigerant that has flowed through flow path 143 is discharged from a discharge portion 142. The refrigerant discharged from discharge portion 142 is air-cooled by a radiator (not shown) and then supplied to supply portion 141.

As shown in FIG. 8, the refrigerant that has flowed in from supply portion 141 flows from the front end side to the rear end side of cooler 14. The refrigerant is then, branched into the left and right sides on the rear end side of cooler 14, and branched into a plurality of (four in FIG. 8) paths on each of the left and right sides of the rear end side of cooler 14. The refrigerant flows from the rear end side to the front end side of cooler 14 through each of the branched paths. Subsequently, the refrigerant merges into one path from a plurality of branched paths on the left and right sides, and is discharged from discharge portion 142 via the respective paths on the left and right sides. This allows the refrigerant flowing through cooler 14 to entirely cool power storage modules 15 inside power storage device case 17.

Since a large current flows through main bus bar 410, main bus bar 410 tends to have a higher temperature. When the temperature of main bus bar 410 increases, there is a risk that a large load will be applied to the portion of connection between connector 411 on one end of main bus bar 410 and bus bar connection terminal 181, and the portion of connection between the other end of main bus bar 410 and external terminal 400A, due to deformation of main bus bar 410 in the direction of its extension.

Thus, as shown in FIG. 7, flow path 143 includes an introduction portion 148 extending from the portion of connection with supply portion 141. Main bus bar 410 includes an overlap portion 412 extending so as to overlap introduction portion 148.

As a result, main bus bar 410 is provided so as to at least partially overlap introduction portion 148, through which cooler refrigerant flows than through the portion of flow path 143 other than introduction portion 148. The portion of main bus bar 410 which is located on cooler 14 is provided so as to be in close contact with the surface of cooler 14 opposite to the rear surface thereof that is in contact with power storage modules 15. Consequently, main bus bar 410 can be cooled sufficiently. This makes it difficult for main bus bar 410 to deform.

In addition, as shown in FIG. 6, main bus bar 410 is provided at a position distant from all of inter-module bus bars 420, 430. Specifically, the “position distant from . . . ” means, for example, a position with a distance of not less than the distance between the center points of two holes of inter-module bus bar 420. This allows main bus bar 410 and inter-module bus bars 420, 430 to be spaced away from each other. As a result, contact between main bus bar 410 and inter-module bus bars 420, 430 can be suppressed. Note that the distance between main bus bar 410 and inter-module bus bar 420 connected to external terminal 400 closest to external terminal 400A connected with main bus bar 410 is an exception, that is, the distance is less than the distance between the center points of two holes of inter-module bus bar 420.

As shown in FIG. 6, sub-bus bar 440 is provided at a position distant from main bus bar 410. Specifically, the “position distant from . . . ” means, for example, a position with a distance of not less than the distance between bus bar connection terminal 182 and external terminal 400B, which are connected with sub-bus bar 440. This allows main bus bar 410 and sub-bus bar 440 to be spaced away from each other. As a result, contact between main bus bar 410 and sub-bus bar 440 can be suppressed.

As shown in FIG. 7, flow path 143 includes a discharge part 149 leading to discharge portion 142, and main bus bar 410 may not include a part that overlaps discharge part 149.

Thus, main bus bar 410 can be prevented from overlapping discharge part 149, through which refrigerant having a higher temperature flows than through the portion of flow path 143 other than discharge part 149. As a result, a temperature rise of main bus bar 410 can be prevented. This makes it difficult for main bus bar 410 to deform.

### Embodiment 2

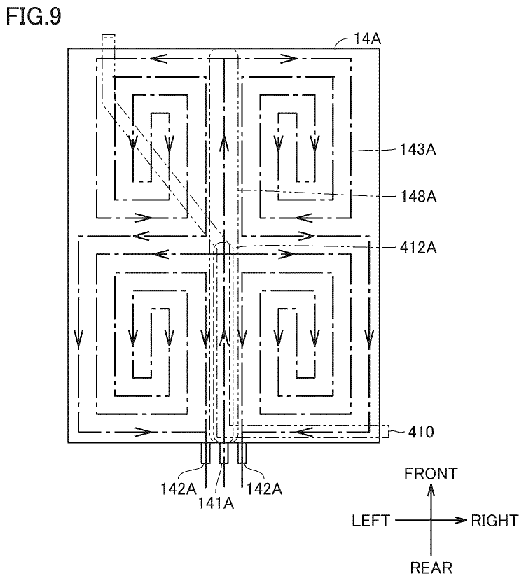

In Embodiment 1, as shown in FIGS. 7 and 8, supply portion 141 and discharge portion 142 are provided at the front end of cooler 14. In Embodiment 2, as shown in FIG. 9, a supply portion 141A and a discharge portion 142A are provided at the rear end of a cooler 14A.

FIG. 9 shows a refrigerant flow in cooler 14A of Embodiment 2. Referring to FIG. 9, in Embodiment 2, supply portion 141A and discharge portion 142A of cooler 14A are provided on the rear end side of cooler 14A.

As shown in FIG. 9, the refrigerant that has flowed in from supply portion 141A flows from the rear end side to the front end side of cooler 14A. The refrigerant is branched into the left and right sides near the middle of cooler 14A and the front end side thereof. Subsequently, the refrigerant flows through the spiral-shaped path shown in FIG. 9, and then merges into one path from two paths branched into the left and right sides, and is discharged from discharge portion 142A through the paths on the left and right sides. This allows the refrigerant flowing through cooler 14A to entirely cool power storage modules 15 inside power storage device case 17.

A flow path 143A includes an introduction portion 148A extending from the portion of connection with supply portion 141A. Main bus bar 410 includes an overlap portion 412A extending so as to overlap introduction portion 148A.

As a result, main bus bar 410 is provided so as to at least partially overlap introduction portion 148A, through which cooler refrigerant flows than through the portion of flow path 143A other than introduction portion 148A. The portion of main bus bar 410 which is located on cooler 14A is provided so as to be in close contact with the surface of cooler 14A opposite to the rear surface thereof that is in contact with power storage modules 15. As a result, main bus bar 410 can be cooled sufficiently. This makes it difficult for main bus bar 410 to deform.

### [Modifications]

(1) The number of power storage modules 15 in the embodiments described above may be more than or less than the number shown in FIGS. 4 and 6. In addition, the power storage modules may be a single power storage module including a plurality of integrally-formed power storage modules 15 of power storage device 11. In this case, the power storage module has two external terminals, that is, external terminal 400A, which is the collective positive electrode terminal described above, and external terminal 400B, which is the collective negative electrode terminal described above.
(2) In the embodiments described above, the positive and negative electrodes described above may all the opposite electrodes.
(3) The path of flow path 143 may be any other path, which is not limited to the paths shown in FIGS. 7 to 9, as long as the flow path includes overlap portion 412, 412A extending so as to overlap introduction portion 148, 148A. In addition, in any other path, main bus bar 410 preferably includes no portion that overlaps discharge part 149.
(4) It is assumed in the embodiments described above that relay box 180 is a connecting device. However, the present disclosure is not limited thereto, and the connecting device may be any other device, for example, a device that has no relay.

### [Concluding Description]

(1) As shown in FIGS. 4 to 6, power storage device 11 includes a storage battery (e.g., one or more power storage modules 15) including a connection terminal (e.g., external terminal 400), relay box 180 provided at a position adjacent to the storage battery, a cooler 14, 14A provided in contact with the storage battery, and main bus bar 410 provided opposite to the storage battery with respect to cooler 14, 14A and connected to the connection terminal and relay box 180. As shown in FIGS. 7 to 9, cooler 14, 14A includes supply portion 141, 141A supplied with the refrigerant, and flow path 143, 143A through which the refrigerant flows. As shown in FIGS. 7 and 9, flow path 143, 143A includes introduction portion 148, 148A extending from the portion of connection with supply portion 141, 141A. As shown in FIGS. 7 and 9, main bus bar 410 includes overlap portion 412, 412A extending so as to overlap introduction portion 148, 148A.

As a result, main bus bar 410 is provided so as to at least partially overlap introduction portion 148, 148A, through which cooler refrigerant flows than through the portion of flow path 143, 143A other than the introduction portion. As a result, main bus bar 410 can be cooled sufficiently. This makes it difficult for main bus bar 410 to deform.
(2) As shown in FIGS. 4 and 6, the storage battery includes power storage modules 15. As shown in FIGS. 4 to 6, each of power storage modules 15 has a positive electrode terminal (e.g., positive-electrode external terminal 400) and a negative electrode terminal (e.g., negative-electrode external terminal 400) and is capable of charging and discharging electric power, and power storage modules 15 are electrically connected in series. As shown in FIG. 6, the connection terminal includes a collective positive electrode terminal (e.g., external terminal 400A) and a collective negative electrode terminal (e.g., external terminal 400B). As shown in FIG. 6, the collective positive electrode terminal is a positive electrode terminal at a terminal end of the series connection of power storage modules 15. As shown in FIG. 6, the collective negative electrode terminal is the negative electrode terminal at a terminal end of the series connection of power storage modules 15. As shown in FIGS. 1 to 9, the first direction (e.g., front-rear direction) is orthogonal to the second direction (e.g., upward-downward direction) and the third direction (e.g., left-right direction). As shown in FIGS. 4 to 6, power storage module 15 is longer in the third direction than in the first direction and the second direction, and has a positive electrode terminal and a negative electrode terminal respectively at the opposite ends in the third direction. As shown in FIGS. 4 and 6, power storage modules 15 are arranged in the first direction such that, at one end in the third direction, the positive electrode terminal and the negative electrode terminal of each of the two adjacent power storage modules 15 of power storage modules 15 are alternately aligned. As shown in FIGS. 4 to 6, power storage device 11 further includes inter-module busbars 420, 430 each connecting the positive electrode terminal and the negative electrode terminal of the two adjacent power storage modules 15 of power storage modules 15 to each other such that power storage modules 15 are all connected in series. As shown in FIGS. 4 and 6, relay box 180 includes a first terminal (e.g., positive-electrode bus bar connection terminal 181) and a second terminal (e.g., negative-electrode bus bar connection terminal 182). As shown in FIGS. 4 and 6, main bus bar 410 connects the first terminal to one terminal (e.g., external terminal 400A, which is the collective positive electrode terminal in FIGS. 4 and 6) of the collective positive electrode terminal or the collective negative electrode terminal, and is provided at a position distant from inter-module bus bars 420, 430, the one terminal being located more distant from relay box 180 than the other terminal is from relay box 180.

This allows main bus bar 410 and inter-module bus bars 420, 430 to be spaced away from each other. As a result, contact between main bus bar 410 and inter-module bus bars 420, 430 can be suppressed.
(3) As shown in FIG. 6, the power storage device further includes sub-bus bar 440 that connects the second terminal to one terminal (e.g., external terminal 400B, which is the collective negative electrode terminal in FIGS. 4 and 6) of the collective positive electrode terminal or the collective negative electrode terminal that is not connected to the first terminal, and sub-bus bar 440 is provided at a position distant from main bus bar 410.

Thus, main bus bar 410 and sub-bus bar 440 can be spaced away from each other. As a result, contact between main bus bar 410 and sub-bus bar 440 can be suppressed.
(4) As shown in FIGS. 7 and 8, cooler 14 may further include discharge portion 142 through which the refrigerant is discharged, flow path 143 may include discharge part 149 leading to discharge portion 142, and main bus bar 410 may not include a part that overlaps discharge part 149.

This can prevent main bus bar 410 from overlapping discharge part 149, through which refrigerant having a higher temperature flows than through the portion of flow path 143 other than discharge part 149. As a result, a temperature rise of main bus bar 410 can be prevented. This makes it difficult for main bus bar 410 to deform.

Although the present embodiments of the present disclosure have been described, it should be understood that the present embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power storage device comprising:
a storage battery including a connection terminal;
a connection device provided at a position adjacent to the storage battery;
a cooler provided in contact with the storage battery; and
a main bus bar provided opposite to the storage battery with respect to the cooler and connected to the connection terminal and the connection device, wherein
the cooler includes
a supply portion supplied with refrigerant, and
a flow path through which the refrigerant flows,
the flow path includes an introduction portion extending from a portion of connection with the supply portion, and
the main bus bar includes an overlap portion extending so as to overlap the introduction portion.

2. The power storage device according to claim 1, wherein
the storage battery includes a plurality of power storage modules,
each of the plurality of power storage modules has a positive electrode terminal and a negative electrode terminal and charges and discharges electric power, and the plurality of power storage modules are electrically connected in series,
the connection terminal includes a collective positive electrode terminal and a collective negative electrode terminal,
the collective positive electrode terminal is the positive electrode terminal at a terminal end of the series connection of the plurality of power storage modules,
the collective negative electrode terminal is the negative electrode terminal at a terminal end of the series connection of the plurality of power storage modules,
a first direction is orthogonal to a second direction and a third direction,
each of the plurality of power storage modules is longer in the third direction than in the first direction and the second direction, and has the positive electrode terminal and the negative electrode terminal respectively at opposite ends in the third direction,
the plurality of power storage modules are arranged in the first direction such that, at one end in the third direction, the positive electrode terminal and the negative electrode terminal of each of two adjacent power storage modules of the plurality of power storage modules are alternately aligned,
the power storage device further comprises a plurality of inter-module bus bars each connecting the positive electrode terminal and the negative electrode terminal of the two adjacent power storage modules to each other such that the plurality of power storage modules are all connected in series,
the connection device includes a first terminal and a second terminal, and
the main bus bar connects the first terminal to one terminal of the collective positive electrode terminal or the collective negative electrode terminal and is provided at a position distant from the plurality of inter-module bus bars, the one terminal being located more distant from the connection device than the other terminal is from the connection device.

3. The power storage device according to claim 2, further comprising a sub-bus bar connecting the second terminal to one terminal of the collective positive electrode terminal or the collective negative electrode terminal, the one terminal not being connected to the first terminal,
wherein the sub-bus bar is provided at a position distant from the main bus bar.

4. The power storage device according to claim 1, wherein
the cooler further includes a discharge portion through which the refrigerant is discharged,
the flow path includes a discharge part leading to the discharge portion, and
the main bus bar does not include a part that overlaps the discharge part.
